(19) United States
(12) Patent Application Publication
(10) Pub. No.: US 2015/0130855 A1
(43) Pub. Date: May 14, 2015

(54) IMAGE DISPLAY SYSTEM AND SIGNAL SYNCHRONIZATION DEVICE THEREOF

(71) Applicants: MING-LUNG TSAI, Hsin-Chu (TW); WEN-PING HO, Hsin-Chu (TW)

(72) Inventors: MING-LUNG TSAI, Hsin-Chu (TW); WEN-PING HO, Hsin-Chu (TW)

(21) Appl. No.: 14/455,260

(22) Filed: Aug. 8, 2014

(30) Foreign Application Priority Data
Nov. 11, 2013 (CN) 201310556300.3

(51) Int. Cl. G09G 3/34; G09G 3/36

(52) U.S. Cl. CPC G09G 3/3406; G09G 3/3696; G09G 2320/0646; G09G 2320/064
USPC 345/690

(57) ABSTRACT

An image display system and a signal synchronization device are provided. The image display system includes an image source, an image projection device and a liquid crystal shutter device. The image source is configured to provide an image signal and a first clock signal. The image projection device is connected to the image source and configured to generate an image projection light signal and a second clock signal according to the image signal and the first clock signal. The liquid crystal shutter device is disposed on a path of the image projection light signal and connected to the image source or the image projection device. The liquid crystal shutter device includes a plurality of liquid crystal molecules and is configured to control a light shading rate of the liquid crystal molecules according to phase changes of the first clock signal or the second clock signal.

### TECHNICAL FIELD

The invention relates to an image display system and a signal synchronization device thereof, and more particularly to an image display system and a signal synchronization device thereof employing smart film and rear projection technology.

### BACKGROUND

Smart film is a technology similar as liquid crystal display (LCD) that uses physical properties of liquid crystal molecules therein and optical characteristics to perform an image display. For example, as illustrated in FIGS. 1A and 1B, liquid crystal molecules 103 are injected between two translucent films 101 and 102; then, an AC voltage 23 is applied to two planar translucent electrodes 104 and 105 so as to control the translucency ratio of the smart film (as illustrated in FIG. 1A). It is to be noted that the transmittance of the smart film is to be reduced to the minimum (as illustrated in FIG. 1B) and accordingly a partially transparent foggy effect is presented when the AC voltage between two planar translucent electrodes 104 and 105 is configured to zero.

The above-mentioned smart film 1 can be used to realize some specific rear projection screen applications as illustrated in FIG. 2. For example, by outputting an image projection light signal 201 from a projector 20 disposed at rear of a translucent glass 21 and controlling the transmittance of the smart film 1 attached on the translucent glass 21, an observer 22 in front of the translucent glass 21 can observe specific visual effects. For example, by superposing two images, the one of the real objects presented behind the translucent glass 21 and the one of being presented on the smart film 1 by the image projection light signal 201, with a specific brightness ratio, thus, a window presentation system is developed and accordingly an observer 22 stood in front of the translucent glass 21 can observe a specific image effect.

However, the conventional rear projection applications generally have color cast and image jitter issues. Because the AC voltage for driving the liquid crystal molecules in the smart film is generally derived from a household AC power which has a frequency range between 60˜100 Hz, the color cast and image jitter issues accordingly occur when the image projection light signal 201 from the projector 20 has different refresh rate or phase difference with the frequency of the supplied AC voltage. Besides, the liquid crystal molecules generally are driven by an AC sine-wave voltage signal and the liquid crystal molecules have the maximum inversion angle at the trough or crest of the AC sine-wave voltage signal. When the three primary light colors of a digital light processing (DLP) projector is penetrating through the liquid crystal molecules, if the liquid crystal molecules not reach to the maximum inversion angle yet, the color cast may occur due to one of the three primary light colors may not penetrate completely.

United States publication number 20110255035 disclosed an image projection device used with a transparent object attached with a light regulation membrane. Specifically, the light regulation membrane is functioned as a screen and accordingly no light can penetrate through the light regulation membrane when the light regulation membrane is not energized; alternatively, the projected light on the light regulation membrane from the image projection device can penetrate through the light regulation membrane when the light regulation membrane is energized. Another U.S. Pat. No. 5,963,276 disclosed a liquid crystal array capable of enhancing the contract by modulating the light pattern before the light reaching the screen.

### SUMMARY OF THE INVENTION

The invention provides an image display system, which includes an image source, an image projection device and a liquid crystal shutter device. The image source is configured to provide an image signal and a first clock signal. The image projection device is connected to the image source and configured to generate an image projection signal and a second clock signal according to the image signal and the first clock signal. The liquid crystal shutter device is disposed on a path of the image projection light signal and connected to the image source or the image projection device. The liquid crystal shutter device includes a plurality of liquid crystal molecules and is configured to control a light shading rate of the liquid crystal molecules according to phase changes of the first clock signal or the second clock signal.

In one embodiment according to the invention, the image source is a digital image file player, and the image signal is a video graphics array (VGA) signal, a high definition multimedia interface (HDMI) signal or a display port (DP) signal.

In one embodiment according to the invention, the first clock signal is a vertical synchronization signal and the second clock signal is a refresh rate signal.

In one embodiment, the liquid crystal shutter device is further configured to drive the liquid crystal molecules to perform a polarity inversion operation according to a polarity inversion voltage signal; the polarity inversion voltage signal is generated according to the first clock signal or the second clock signal; and the polarity inversion voltage signal is configured to synchronize with the phase change of the first clock signal or the second clock signal.

In one embodiment according to the invention, the polarity inversion voltage signal is generated by the liquid crystal shutter device, the image source or the image projection device.

In one embodiment according to the invention, the polarity inversion voltage signal is a DC voltage square-wave signal.

The invention further provides a signal synchronization device applied in an image display system. The image display system includes an image source, an image projection device and a liquid crystal shutter device. The image source is configured to provide an image signal and a first clock signal. The image projection device is connected to the image source and configured to generate an image projection light signal and a second clock signal according to the image signal and the first clock signal. The liquid crystal shutter device is disposed on a path of the image projection light signal. The liquid crystal shutter device includes a plurality of liquid crystal molecules and is configured to control a light shading rate of the liquid crystal molecules according to a phase change of a polarity inversion voltage signal. The signal synchronization device is connected to the image source or the image projection device and configured to generate the polarity inversion voltage signal to the liquid crystal shutter device according to the first clock signal or the second clock signal. The polarity inversion voltage signal is configured to synchronize with the phase of the first clock signal or the second clock signal.

In one embodiment according to the invention, the polarity inversion voltage signal is a DC voltage square-wave signal.

The invention still further provides an image display system, which includes an image source, an image projection device and a liquid crystal shutter device. The image source is configured to provide an image signal. The image projection device is connected to the image source and configured to generate an image projection light signal according to the image signal. The liquid crystal shutter device is disposed on a path of the image projection light signal. The liquid crystal shutter device includes a plurality of liquid crystal molecules and is configured to control a light shading rate of the liquid crystal molecules according to a DC voltage square-wave signal.

In one embodiment according to the invention, the liquid crystal shutter device is connected to the image source or the image projection device. The image source is further configured to provide a first clock signal, and the image projection device is further configured to generate the image projection light signal and a second clock signal according to the image signal and the first clock signal. The DC voltage square-wave signal is generated according to the first clock signal or the second clock signal, and the DC voltage square-wave signal is configured to synchronize with the phase change of the first clock signal or the second clock signal.

### BRIEF DESCRIPTION OF THE DRAWINGS

The invention will become more readily apparent to those ordinarily skilled in the art after reviewing the following detailed description and accompanying drawings.

FIGS. 1A and 1B are diagrams schematically illustrating an operation of a smart film;

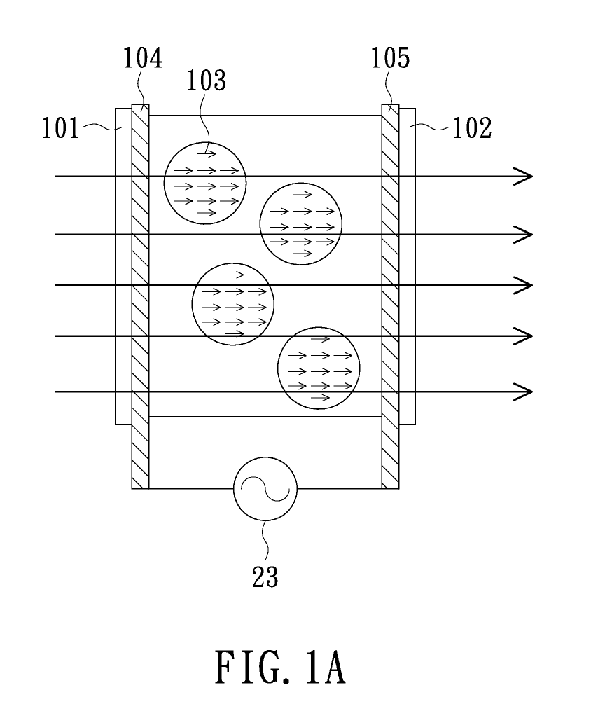

FIG. 2 is a schematic diagram illustrating a conventional structure of a rear projection screen realized by a smart film;

FIG. 3 is a schematic diagram of an image display system in accordance with a first embodiment of the invention;

FIG. 4 is a schematic diagram of an image display system in accordance with a second embodiment of the invention;

FIG. 5 is a schematic diagram of a system in accordance with a third embodiment of the invention;

FIG. 6 is a schematic diagram of a system in accordance with a fourth embodiment of the invention; and

FIG. 7 is a schematic diagram of a circuit for generating a DC voltage signal.

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

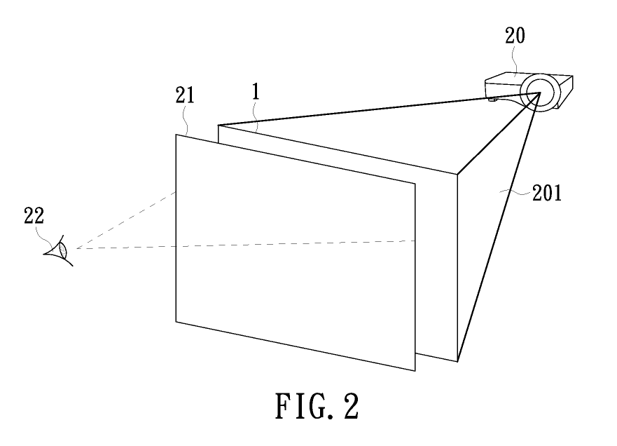

Please refer to FIG. 3. FIG. 3 is a schematic diagram of an image display system in accordance with a first embodiment of the invention. As shown in FIG. 3, the image display system in this embodiment includes an image source 30, an image projection device 31 (such as a projector) and a liquid crystal shutter device 32, wherein the image source 30 is configured to provide an image signal I and a first clock signal Clk1, and the phase between the image signal I and the first clock signal Clk1 is synchronized with each other. The first clock signal Clk1 may also be inserted into the image signal I and then outputted together. The image projection device 31 is connected to the image source 30 and configured to generate an image projection signal L according to the image signal I and the first clock signal Clk1. The liquid crystal shutter device 32 is disposed on a path of the image projection light signal L of the image projection device 31 and connected to the image source 30. The liquid crystal shutter device 32 includes a plurality of liquid crystal molecules (not shown) and is configured to control the light shading rate of the liquid crystal molecules according to the phase change of the first clock signal Clk1 provided by the image source 30. The first clock signal Clk1 may be a vertical synchronization (V-Sync) signal which is used commonly in the image source 30, however, the invention is not limited thereto. Furthermore, the image source 30 and the image projection device 31 may be integrated as one image device so as to provide the image signal I, the first clock signal Clk1 and generate the image projection light signal L.

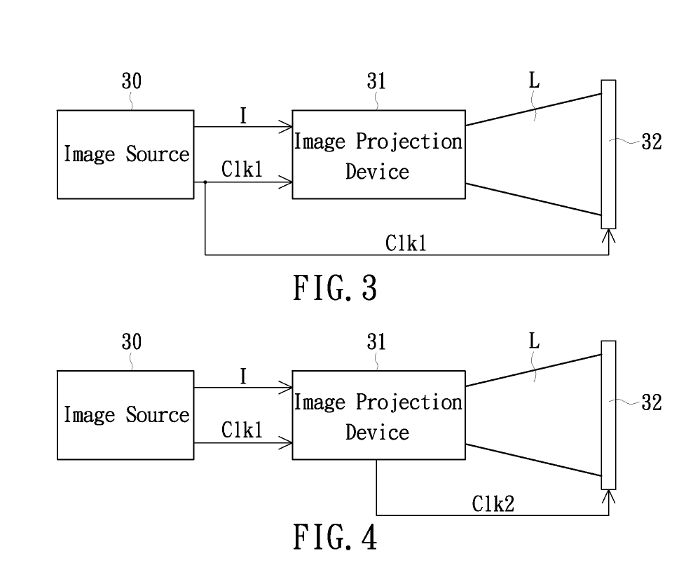

Please refer to FIG. 4. FIG. 4 is a schematic diagram of an image display system in accordance with a second embodiment of the invention. As shown in FIG. 4, the image display system in this embodiment includes an image source 30, an image projection device 31 and a liquid crystal shutter device 32. The image source 30 is configured to provide an image signal I and a first clock signal Clk1, wherein the phase of the image signal I and the phase of the first clock signal Clk1 are synchronized with each other. The first clock signal Clk1 may also be inserted into the image signal I and then outputted together. The image projection device 31 is connected to the image source 30 and configured to generate an image projection signal L and a second clock signal Clk2 according to the image signal I and the first clock signal Clk1. The liquid crystal shutter device 32 is disposed on a path of the image projection light signal L of the image projection device 31 and connected to the image projection device 31. The liquid crystal shutter device 32 includes a plurality of liquid crystal molecules (not shown) and is configured to control the light shading rate of the liquid crystal molecules according to the phase change of the second clock signal Clk2 provided by the image projection device 31. In one embodiment, the second clock signal Clk2 may be a frame frequency signal which is used commonly in the image projection device 31, however, the invention is not limited thereto.

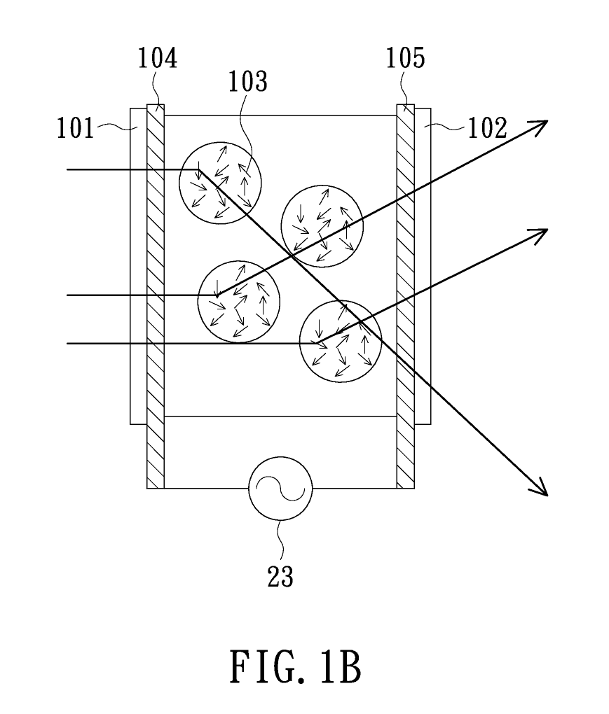

The image source 30 can be a digital image file player, such as a digital video device player (DVD), a laptop computer or other similar devices. The image signal provided from the image source 30 can be a video graphics array (VGA) signal, a high definition multimedia interface (HDMI) signal, a display port (DP) signal or other similar image signals. The image projection device 31 can be a digital light processing (DLP) projector or other types of time sequence imaging projector. The liquid crystal shutter device 32 can be the smart film 1 which is illustrated in FIG. 2. The liquid crystal shutter device 32 (or the smart film 1) is configured to drive the liquid crystal molecules therein to perform a polarity inversion operation according to a polarity inversion voltage signal, wherein the polarity inversion voltage signal is synchronized with the phase of the clock signal Clk1 or Clk2. The polarity inversion voltage signal is generated by the smart film 1 electrically connected with a power source, according to the phases of the clock signals Clk1 or Clk2. In another embodiment, the polarity inversion voltage signal is generated by either the image source 30 or the image projection device 31 according to the clock signals Clk1 or Clk2. Thus, when the phase change of polarity inversion voltage signal is synchronized with the phase change of the clock signals Clk1 or Clk2, the refresh rate of the image projection device 31 is synchronized with the phase of the polarity inversion voltage signal. Therefore, the stability of the image penetrating through the liquid crystal shutter device 32 is maintained.

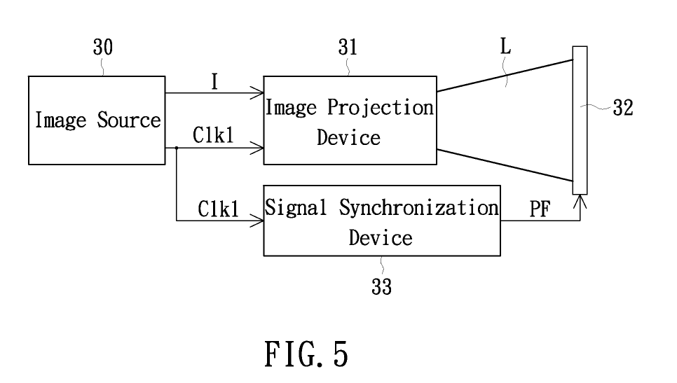

Please refer to FIG. 5. FIG. 5 is a schematic diagram of a system in accordance with a third embodiment of invention. As shown in FIG. 5, the system in this embodiment mainly includes an image display system and a signal synchronization device. The image display system includes an image source 30, an image projection device 31 and a liquid crystal shutter device 32. The image source 30 is configured to provide an image signal I and a first clock signal Clk1, wherein the phase of image signal I and the phase of first clock signal Clk1 are configured to be synchronized with each other. The first clock signal Clk1 may also be inserted into the image signal I and then outputted together. The image projection device 31 is connected to the image source 30 and configured to generate an image projection signal L according to the image signal I and the first clock signal Clk1. The signal synchronization device 33 is connected to the image source 30 and configured to generate a polarity inversion voltage signal PF according to the first clock signal Clk1 and then output the polarity inversion voltage signal PF to the liquid crystal shutter device 32, wherein the phase of the polarity inversion voltage signal PF and the phase of the first clock signal Clk1 are synchronized with each other. The liquid crystal shutter device 32 is disposed on a path of the image projection light signal L of the image projection device 31 and connected to the signal synchronization device 33. The liquid crystal shutter device 32 includes a plurality of liquid crystal molecules (not shown) and is configured to control the light shading rate of the liquid crystal molecules according to the phase change of the polarity inversion voltage signal PF.

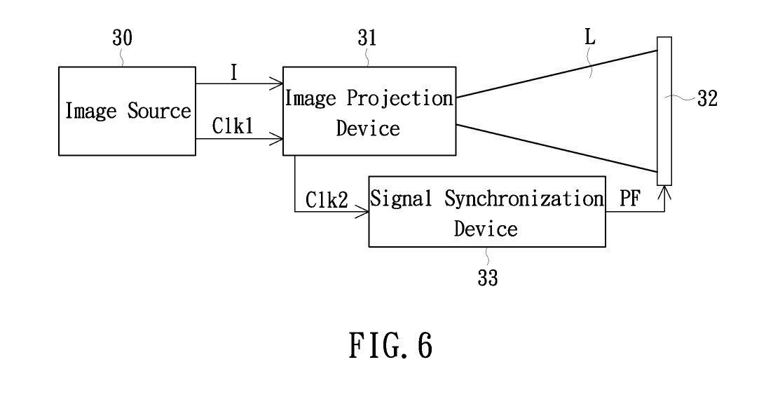

Please refer to FIG. 6. FIG. 6 is a schematic diagram of a system in accordance with a fourth embodiment of invention. As shown in FIG. 6, the system in this embodiment mainly includes an image display system and a signal synchronization device. The image display system includes an image source 30, an image projection device 31 and a liquid crystal shutter device 32. The image source 30 is configured to provide an image signal I and a first clock signal Clk1, wherein the phase of the image signal I and the phase of the first clock signal Clk1 are synchronized with each other. The first clock signal Clk1 may be inserted into the image signal I and then outputted together. The image projection device 31 is connected to the image source 30 and configured to generate an image projection signal L and a second clock signal Clk2 according to the image signal I and the first clock signal Clk1. The signal synchronization device 33 is connected to the image projection device 31 and configured to generate a polarity inversion voltage signal PF according to the second clock signal Clk2 and then output the polarity inversion voltage signal PF to the liquid crystal shutter device 32, wherein the phase of the polarity inversion voltage signal PF and the phase of the second clock signal Clk2 are synchronized with each other. The liquid crystal shutter device 32 is disposed on a path of the image projection light signal L of the image projection device 31 and connected to the signal synchronization device 33. The liquid crystal shutter device 32 includes a plurality of liquid crystal molecules (not shown) and is configured to control the light shading rate of the liquid crystal molecules according to the phase change of the polarity inversion voltage signal PF.

Similarly, the above-mentioned polarity inversion voltage signal PF is generated according to the clock signals Clk1 or Clk2. As a result, when the phase of the polarity inversion voltage signal RF and the phases of the clock signals Clk1 or Clk2 are synchronized with each other, the refresh rate of the image projection device 31 is synchronized with the phase of the polarity inversion voltage signal FR. Consequentially, the stability of the image penetrating through the liquid crystal shutter device 32 is maintained.

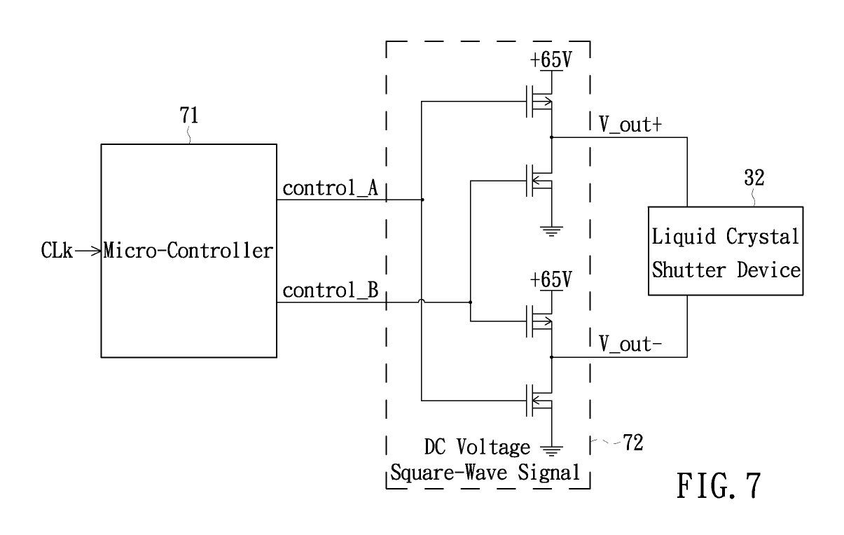

FIG. 7 is a schematic diagram of a circuit for generating a DC voltage square-wave signal, wherein the circuit may be integrated with the above-mentioned image source 30, the image projection device 31, the liquid crystal shutter device 32 or the signal synchronization device 33 based on various embodiments. As shown in FIG. 7, the circuit mainly includes a micro-controller 71 and a DC voltage square-wave signal generator 72. Specifically, the micro-controller 71 is configured to output two digital square-wave control signals control_A and control_B according to the clock signal Clk, wherein the clock signal Clk is a vertical synchronization signal or a refresh rate signal, and the phases of the two digital square-wave control signals control_A and control_B are opposite with each other. The DC voltage square-wave signal generator 72 is composed of four transistors and a DC voltage source (e.g., 65V), wherein the DC voltage square-wave signal generator 72 is controlled in order to generate a DC voltage square-wave signal for the liquid crystal shutter device 32 therein. Moreover, it is to be noted that the phase of the DC voltage square-wave signal and the refresh rate of the image projection device 31 are synchronized with each other, however, it is not necessarily to synchronize the two signals to have the same frequency, for example, the two signals may have a multiple relationship.

In summary, by generating the polarity inversion voltage signal or the DC voltage square-wave signal synchronized with the refresh rate of the image projection device 31, the invention provides a power source for driving the liquid crystal shutter device 32 according to the clock signal Clk such as the vertical synchronization signal or the refresh rate signal. Thus, the invention can fix the color cast and image jitter issues occurring in prior art.

Although in the preferred embodiments of the invention have been described in detail for purposes of illustration, various modifications and enhancements may be made without departing from the spirit and scope of the invention, thus, the scope of invention accompany authority when reviewing claims hereafter whichever is defined. In addition, any one of embodiments or claims request need not reach an agreement of all purposes of disclosures or merits or distinctive features in the invention.

Furthermore, the abstract and subject are only served for auxiliary use to patent search purpose, and not intended to limit the scope of invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image display system, comprising:
an image source configured to provide an image signal and a first clock signal;
an image projection device connected to the image source and configured to generate an image projection light signal and a second clock signal according to the image signal and the first clock signal; and
a liquid crystal shutter device disposed on a path of the image projection light signal and connected to the image source or the image projection device, the liquid crystal shutter device comprising a plurality of liquid crystal molecules and being configured to control a light shading rate of the liquid crystal molecules according to phase changes of the first clock signal or the second clock signal.

2. The image display system according to claim 1, wherein the image source is a digital image file player and the image signal is a video graphics array (VGA) signal, a high definition multimedia interface (HDMI) signal or a display port (DP) signal.

3. The image display system according to claim 1, wherein the first clock signal is a vertical synchronization signal and the second clock signal is a refresh rate signal.

4. The image display system according to claim 1, wherein the liquid crystal shutter device is further configured to drive the liquid crystal molecules to perform a polarity inversion operation according to a polarity inversion voltage signal, the polarity inversion voltage signal is generated according to the first clock signal or the second clock signal, the polarity inversion voltage signal is synchronized with a phase change of the first clock signal or the second clock signal.

5. The image display system according to claim 4, wherein the polarity inversion voltage signal is generated by the liquid crystal shutter device, the image source or the image projection device.

6. The image display system according to claim 4, wherein the polarity inversion voltage signal is a DC voltage square-wave signal.

7. A signal synchronization device applied in an image display system, the image display system comprising;
an image source configured to provide an image signal and a first clock signal;
an image projection device connected to the image source and configured to generate an image projection light signal and a second clock signal according to the image signal and the first clock signal; and
a liquid crystal shutter device disposed on a path of the image projection light signal, the liquid crystal shutter device comprising a plurality of liquid crystal molecules and being configured to control a light shading rate of the liquid crystal molecules according to a phase change of a polarity inversion voltage signal, wherein the signal synchronization device is connected to the image source or the image projection device and configured to generate the polarity inversion voltage signal to the liquid crystal shutter device according to the first clock signal or the second clock signal, and the polarity inversion voltage signal is configured to synchronized with the phase of the first clock signal or the second clock signal.

8. The signal synchronization device according to claim 7, wherein the polarity inversion voltage signal is a DC voltage square-wave signal.

9. An image display system, comprising:
an image source configured to provide an image signal;
an image projection device connected to the image source and configured to generate an image projection light signal according to the image signal; and
a liquid crystal shutter device disposed on a path of the image projection light signal, the liquid crystal shutter device comprising a plurality of liquid crystal molecules and being configured to control a light shading rate of the liquid crystal molecules according to a DC voltage square-wave signal.

10. The image display system according to claim 9, wherein the liquid crystal shutter device is connected to the image source or the image projection device, the image source is further configured to provide a first clock signal, the image projection device is further configured to generate the image projection light signal and a second clock signal according to the image signal and the first clock signal, the DC voltage square-wave signal is generated according to the first clock signal or the second clock signal, and the DC voltage square-wave signal is configured to synchronized with the phase change of the first clock signal or the second clock signal.

11. The image display system according to claim 10, wherein the DC voltage square-wave signal is generated according to the liquid crystal shutter device, the image source or the image projection device.

12. The image display system according to claim 10, wherein the image source is a digital image file player and the image signal is a video graphics array (VGA) signal, a high definition multimedia interface (HDMI) signal or a display port (DP) signal.

13. The image display system according to claim 10, wherein the first clock signal is a vertical synchronization signal and the second clock signal is a refresh rate signal.
